(19) United States
(12) Patent Application Publication
(10) Pub. No.: US 2026/0014887 A1
(43) Pub. Date: Jan. 15, 2026

(54) METHOD AND SYSTEM FOR POSITIONING A VEHICLE HAVING WIRELESS POWER TRANSFER BASED ON MAGNETIC FLUX SENSING

(71) Applicant: Electreon Wireless Ltd., Beit Yanai (IL)

(72) Inventor: Andreas WENDT, Köln (DE)

(73) Assignee: Electreon Wireless Ltd., Beit Yanai (IL)

(21) Appl. No.: 19/334,021

(22) Filed: Sep. 19, 2025

Related U.S. Application Data
(63) Continuation of application No. PCT/IL2024/050098, filed on Jan. 24, 2024.
(60) Provisional application No. 63/453,605, filed on Mar. 21, 2023.

(51) Int. Cl. B60L 53/39; B60L 53/122; B60L 53/36; B60W 60/00; H02J 50/10; H02J 50/40; H02J 50/90

(52) U.S. Cl. CPC B60L 53/39; B60L 53/122; B60L 53/36; B60W 60/001; H02J 50/10; H02J 50/402; H02J 50/90

(57) ABSTRACT

A system for positioning wirelessly powered or charged electric vehicles is provided herein. The system includes: a plurality of partially overlapping coils forming a power receiver segment attached to the electric vehicle; a set of two or more coils located symmetrically on the power receiver segment and connected to respective rectifiers and digital voltmeters; a set of three or more coils located along a longitudinal centre of the power receiver segment and connected to connected to respective rectifiers and digital voltmeters; a computer processor configured to receive samples from the digital voltmeters and calculate, based on calibration data, a position of the electric vehicle relative to the powers transmitting coils located below the road, wherein the calibration data map voltage values representative of magnetic flux though the set of three coils and the set of fur coils, into longitudinal and lateral displacement of the receiver segment, respectively.

### CROSS REFERENCE TO RELATED APPLICATIONS

This Application is a continuation of PCT Application No. PCT/IL2024/050098 having International Filing Date Jan. 24, 2024, which claims the benefit of U.S. Provisional Patent Application No. 63/453,605 filed on Mar. 21, 2023, both of which are incorporated herein by reference in their entirety.

### FIELD OF THE INVENTION

The present invention relates generally to wireless power transmission in electric vehicles and more specifically sensing the magnetic flux for positioning the electric vehicles.

### BACKGROUND OF THE INVENTION

Prior to setting forth the background of the invention, the following term definitions are provided herein and may be used throughout the description.

The term ‘electric vehicle’ refers generally to a vehicle powered solely, or in part, by electrical energy stored (e.g., chemically) in a battery, or the like. In the present context, an ‘electric vehicle’ moreover has provision for receiving (e.g., at coils disposed on the underside of the vehicle) a wirelessly induced electromotive force (i.e., voltage) that may be stored or otherwise utilized to recharge the battery. For an electromagnetically induced voltage to occur, the vehicle (i.e., the ‘conductor’) may be moving relative to a magnetic field which is, for example, projected about the road upon which the vehicle is travelling. Alternatively, the magnetic field may be periodically varied (e.g., through use of alternating current) thereby inducing a voltage at the vehicle.

The term ‘road section’ refers generally to a portion of, for example, a highway or motorway which has been modified to comprise a medium for wirelessly transmitting power (i.e., a ‘power transmitter’). This may mean that the road comprises a plurality of coils embedded beneath the surface of the road section which are operable to emit a magnetic field. In typical arrangements, the medium (coils) may be connected to an alternating current source, e.g. an electrical grid, and may generate a varying magnetic field, thereby inducing a voltage in any proximate conductor. One possible approach to powering on-road electric vehicles via wireless power transfer is disclosed in EP 3089886 B1 and is incorporated herein by reference.

FIG. 1 is a block diagram illustrating a prior art wireless power transmission system 100. Wireless power transmission system 100 may include a plurality of electric vehicles 150 comprising an attached power receiver, for example, to an underside of the vehicle. The plurality of electric vehicles may further travel upon a road section 101 having one or more power transmitters 120 disposed, for example, underneath the surface of the road section and fed by power converter 122 connected to an electrical grid. In some embodiments, each power receiver and power transmitter may comprise one or more wound or looped coils coupled, for example, to an alternating current source. In some arrangements, these coils may be operable to emit a static or varying magnetic field into a vicinity about the coils, for example around the road section or portions thereof. As each electric vehicle travels along road section 101, a magnetic field formed by power transmitters in road section 101 induces a voltage in each power receiver and is stored and/or converted by the electric vehicle into, for example, chemical energy in a battery. In alternative embodiments, the induced energy may be immediately used by an engine of the electric vehicle without storage.

As the electric vehicle passes over the transmitting coils the alignment of the receiving coils with respect to the transmitting coils changes. This affects the magnetic flux through the coils as a function of the position of the receiver coils on electric vehicles 150 with regard to the power transmitters 120.

### SUMMARY OF THE PRESENT INVENTION

The present invention provides a system for positioning wirelessly powered or charged electric vehicle. The system includes: a plurality of partially overlapping coils forming a power receiver segment attached to the electric vehicle; a set of two or more coils located symmetrically on the power receiver segment and connected to respective rectifiers and digital voltmeters; a set of three or more coils located along a longitudinal centre of the power receiver segment and connected to connected to respective rectifiers and digital voltmeters; a computer processor configured to receive samples from the digital voltmeters and calculate, based on calibration data, a position of the electric vehicle relative to the power transmitting coils located below the road, wherein the calibration data map voltage values representative of magnetic flux though the set of three coils and the set of fur coils, into longitudinal and lateral displacement of the receiver segment, respectively.

This multi-coil sensing environment could be adopted for different applications, by employing a different number or geometry of sensing coils. In some embodiments, seven additional sensing coils (on top of the three power receiver coils) are proposed to define the vehicle's position, based on their induced voltages. The information is meant to be used for two-dimensional positioning support (static charging), and one-dimensional driving support (dynamic charging) and/or performance validation (time-based absolute position logging).

These and other advantages of the present invention are set forth in detail in the following description.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a block diagram showing wireless power transmission system for an electric vehicle on a road in accordance with the prior art;

FIG. 2 is a diagram of power of the air transmitter-receiver pair with additional coils for sensing the magnetic flux in accordance with some embodiments of the present invention;

FIGS. 3A and 3B are diagram of power of the air transmitter-receiver pair with additional coils for sensing the magnetic flux in accordance with some embodiments of the present invention;

FIG. 4 is a circuit diagram showing a magnetic flux sensor in accordance with some embodiments of the present invention;

FIG. 5 is a graph diagram showing an aspect of a magnetic flux sensor in accordance with some embodiments of the present invention;

FIG. 6A is a circuit diagram showing an array of magnetic flux sensors for sensing longitudinal position of the electric vehicle in accordance with some embodiments of the present invention;

FIG. 6B is a circuit diagram showing an array of magnetic flux sensors for sensing lateral position of the electric vehicle in accordance with some embodiments of the present invention;

FIGS. 7A-7F show magnetic flux diagrams of the system in accordance with some embodiments of the present invention;

FIGS. 8A-8D show magnetic flux diagrams of the system in accordance with some embodiments of the present invention;

FIG. 9A shows magnetic flux diagrams of the system in accordance with some embodiments of the present invention;

FIG. 9B is a graph diagram showing the relationship between magnetic flux and the position of the electric vehicle accordance with some embodiments of the present invention;

FIG. 10 shows magnetic flux diagrams of the system in accordance with some embodiments of the present invention;

FIG. 11 shows graph diagrams showing the relationship between magnetic flux and the position of the electric vehicle accordance with some embodiments of the present invention;

FIG. 12 shows a circuit diagram with eliminated coils as a simplified implementation in accordance with embodiments of the present invention;

FIG. 13 shows a circuit with the measurement rectifiers (MR) connected in a differential measurement set-up in accordance with some embodiments of the present invention;

FIG. 14 shows a circuit with the output of measurement rectifier connected in series and counter-series thereby providing values that can be combined to a value proportional to the lateral offset;

FIG. 15 shows a circuit where direct sampling of the induced voltage is implemented in accordance with embodiments of the present invention; and

FIG. 16 shows a vehicle according to an aspect of the present invention.

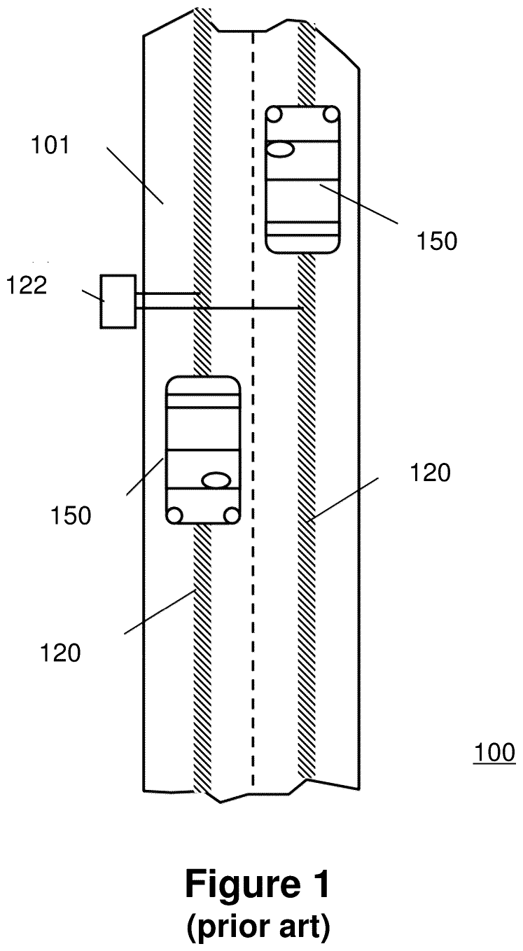

### DETAILED DESCRIPTION OF THE INVENTION

With specific reference now to the drawings in detail, it is stressed that the particulars shown are for the purpose of example and solely for discussing the preferred embodiments of the present invention and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

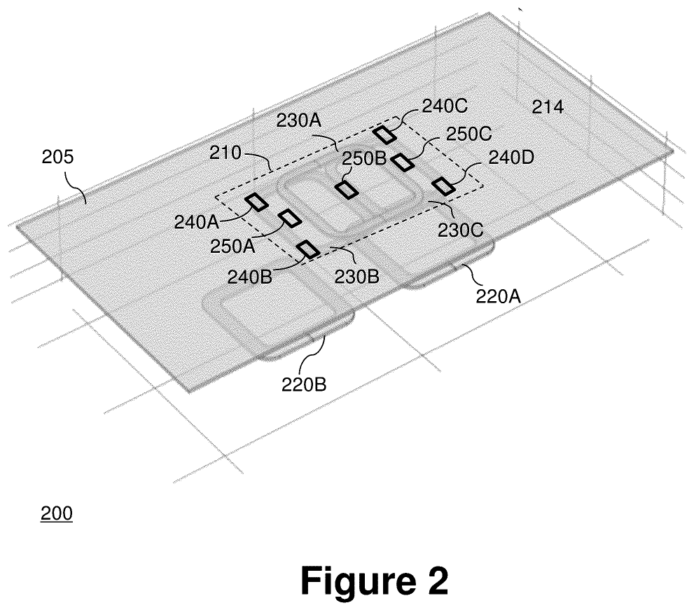

FIG. 2 shows an exemplary arrangement of receiver coils in a receiver array 200. Measurements shown demonstrate exemplary dimensions only and are not intended to be limiting. Receiving coils may be disposed on the underside of an electric vehicle (not shown), parallel to a road having a road section disposed with transmitting coils 220. Receiving coils may receive power transmitted by transmitting coils 220. Lower receiving coils 230B and 230C may be placed edge to edge thereby defining a joining line in the shared plane of the road section and of the coils. Such joined coils 230B and 230C may be referred to as a “figure-of-8” coil. An upper receiving coil 230A may be placed over top of the lower receiving coils 230B and 230C. Upper receiving coil 230A may have dimensions different than those of lower receiving coils 230B and 230C and upper receiving coil 230A may have dimensions identical to those of transmitting coils 200A and 220B. Upper receiving coil 230A may be placed so as to have its geometric center lying on the joining line of the lower receiving coils 230B and 230C. The geometric center of an object is defined as the mean position of all the points of the object in all of the coordinate directions. The configuration of upper and lower receiving coils may be repeated periodically along the underside of the electric vehicle. The receiving coils may be circular or rectangular or variations thereof, e.g., oval or oblong in shape. Receiver array 200 may include a ferrite plate 210 and a radiation shield 205 for electromagnetic compliance (EMC) and to prevent any adverse effects arising from transmission of magnetic flux through to the interior of the electric vehicle. When deployed ferrite plate 210 acts to shape and contain magnetic flux and increase the inductance.

In accordance with embodiments of the present invention, a set of four coils 240A-240D are located at the four corners of the power receiver segment 200 or in other locations and connected to respective rectifiers and digital voltmeters (not shown here). In addition, a set of three coils 250A-250C are located along a longitudinal centre of the power receiver segment 200 and connected to connected to respective rectifiers and digital voltmeters (not shown here).

A computer processor or any other processing unit (not shown here) is configured to receive samples from the digital voltmeters and calculate, based on calibration data, a position of the electric vehicle relative to the power transmitting coils located below the road.

In accordance with embodiments of the present invention, the calibration data is configured to map voltage values representative of magnetic flux though the set of three coils and the set of fur coils, into longitudinal and lateral displacement of the receiver segment, respectively.

By way of a non-limiting example, the dimensions of the additional seven sensing coils may me as illustrated below in Table (1) in which (0,0) is defined to be the geometrical center of the ferrite assembly. Width and Height of the coils may be 2 mm, each with a turn number is 2, but can be scaled as needed.

TABLE 1

| | | | Outer Diameter | Outer Diameter |
|---|---|---|---|---|
| Coil | Center X | Center Y | X | X |
| DIFF | 0 | 0 | 200 | 300 |
| PLUSX | +330 | 0 | 100 | 300 |
| NEGX | −330 | 0 | | |
| FL | +360 | +255 | 200 | 100 |
| FR | +360 | −255 | | |
| RL | −360 | +255 | | |
| RR | −360 | −255 | | |

In the table above, ‘X’ denotes advancement direction of the electric vehicle along the road where ‘Y’ denotes lateral shift of the vehicle on the road.

In some embodiments, displacement along a third axis ‘Z’ may also be sensed using an inertial measurement unit (IMU) or the like. The readings from the IMU may be used to calculate the displacement from the road and thus provide insight with regard to the air gap. This may be important in order to monitor the efficiency of the wireless power transfer.

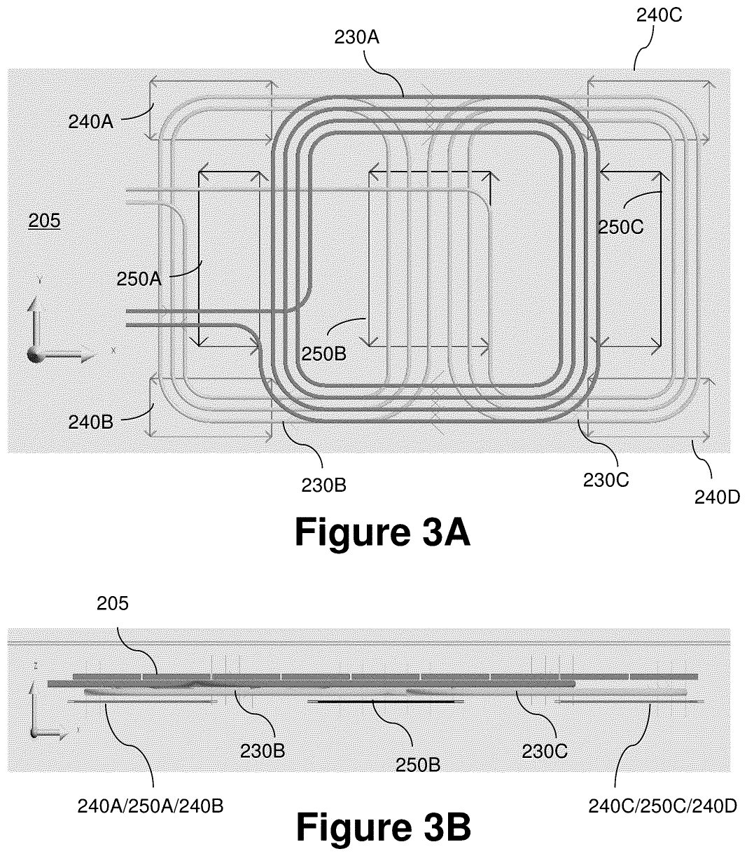

FIGS. 3A and 3B are diagram of power of the air transmitter-receiver pair with additional coils for sensing the magnetic flux in accordance with some embodiments of the present invention. In accordance with embodiments of the present invention, a set of four coils 240A-240D are located at the four corners of the power receiver segment and connected to respective rectifiers and digital voltmeters (not shown here). In addition, a set of three coils 250A-250C are located along a longitudinal centre of the power receiver segment 200 and connected to connected to respective rectifiers and digital voltmeters (not shown here). The sensing coils are shown here in greater detail and in accordance with non-limiting dimensions and positions as illustrated by Table (1).

In accordance with some embodiments of the present invention, the sensing coils 240A-240D and 250A-250C are using the power of the air electromagnetic field created by power coils 220A, 220B and 230A-230C in a retrofit arrangement rather than have a standalone magnetic field used for the positioning.

In a static charging configuration, power current/voltage is applied to transmitter coils 220A and 220B so as to generate a sufficient electromagnetic field for the sensing coils. In a dynamic charging configuration, the regular power of the transmitting coils is used by the sensing coils.

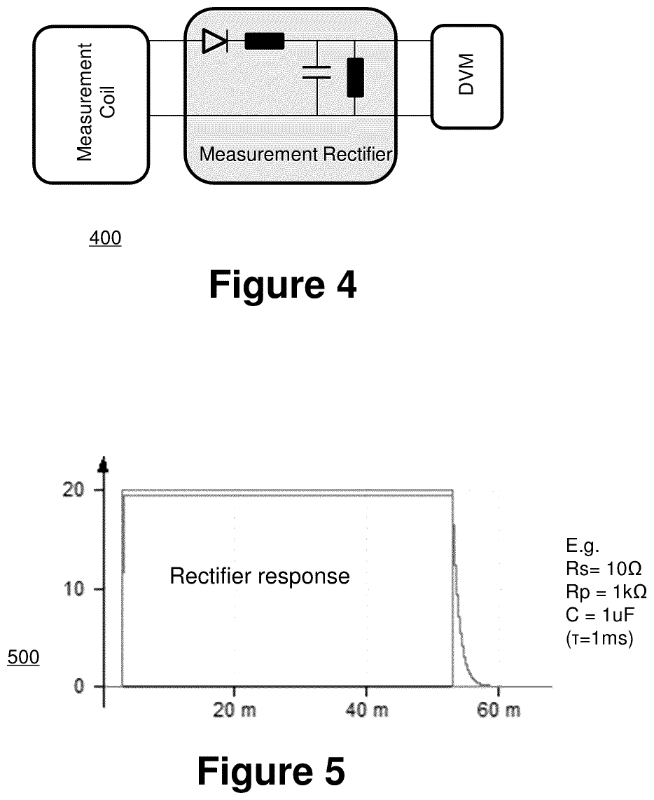

FIG. 4 is a circuit diagram showing a magnetic flux sensor in accordance with some embodiments of the present invention. It is suggested herein to use a simple rectifier between each sensing coil and the digital voltmeter, hence implementing a magnetic flux sensor 400. It is noted that in order to simplify the electronics, only DC voltages are acquired the simple measurement rectifier which is sufficient for all practical purposes.

FIG. 5 is a graph diagram showing an aspect of a magnetic flux sensor in accordance with some embodiments of the present invention. As shown, the rectifier is selected to have a specific response as depicted in 500.

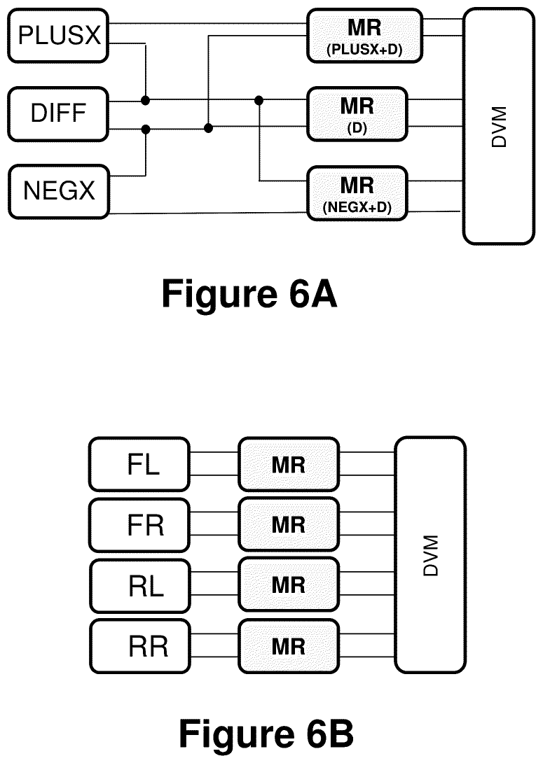

FIG. 6A is a circuit diagram showing an array of magnetic flux sensors for sensing longitudinal position of the electric vehicle in accordance with some embodiments of the present invention. Each coil is coupled to the digital voltmeter via a respective rectifier.

FIG. 6B is a circuit diagram showing an array of magnetic flux sensors for sensing lateral position of the electric vehicle in accordance with some embodiments of the present invention. Each coil is coupled to the digital voltmeter via a respective rectifier.

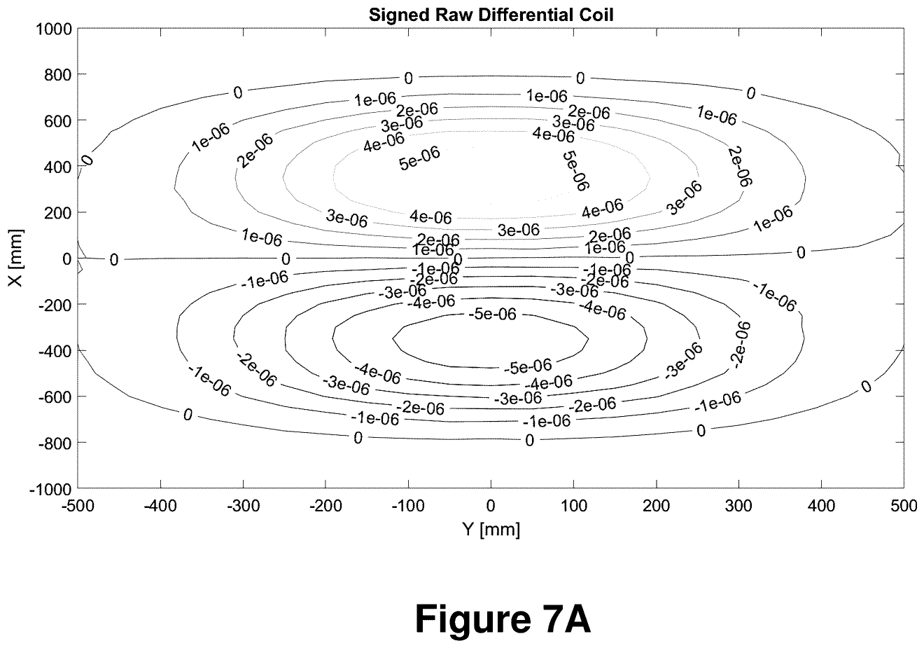

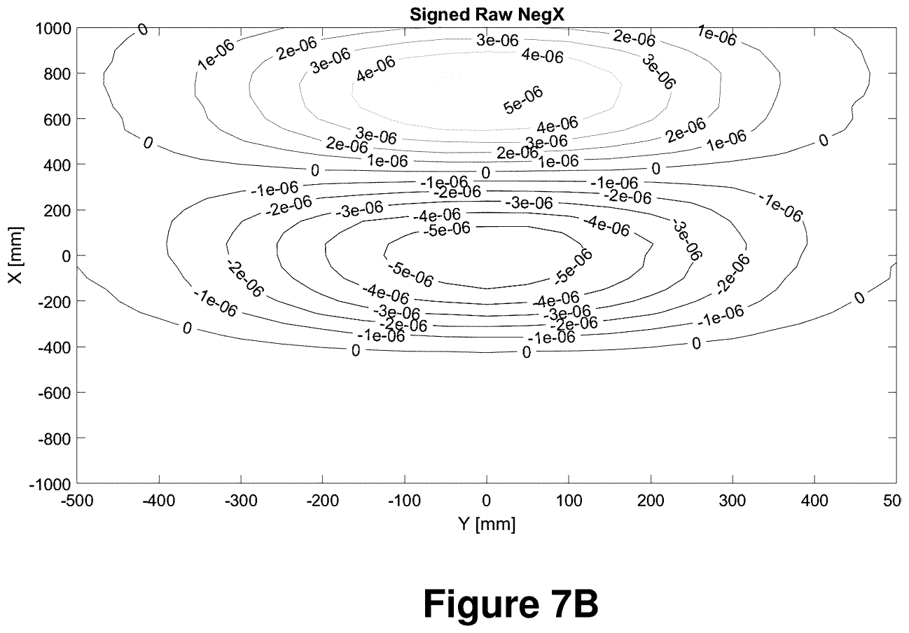

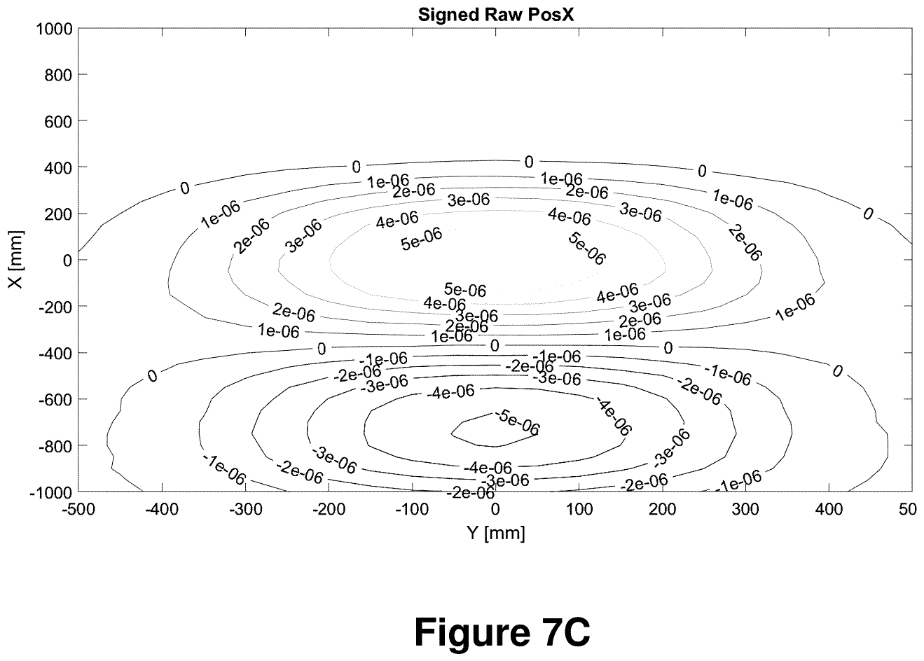

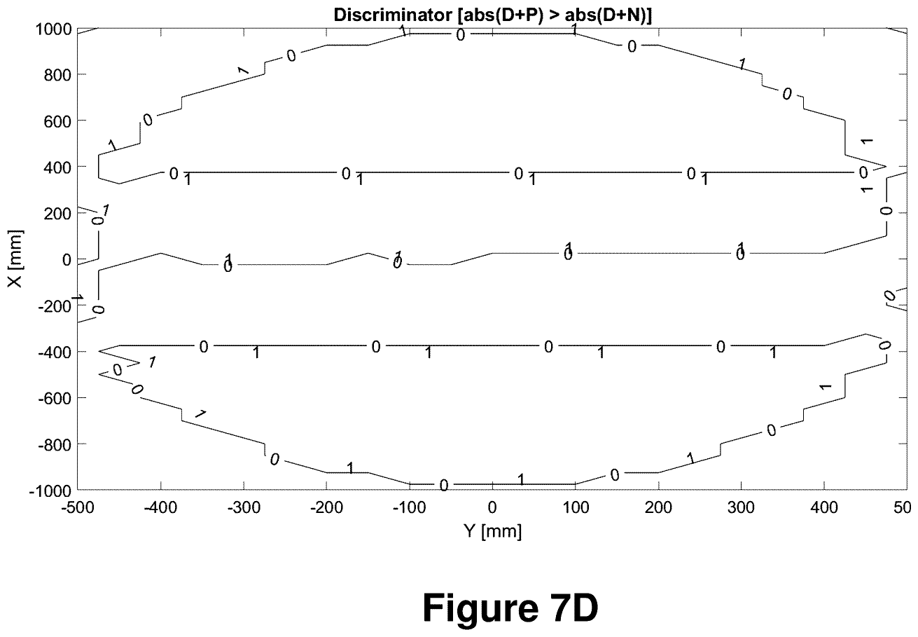

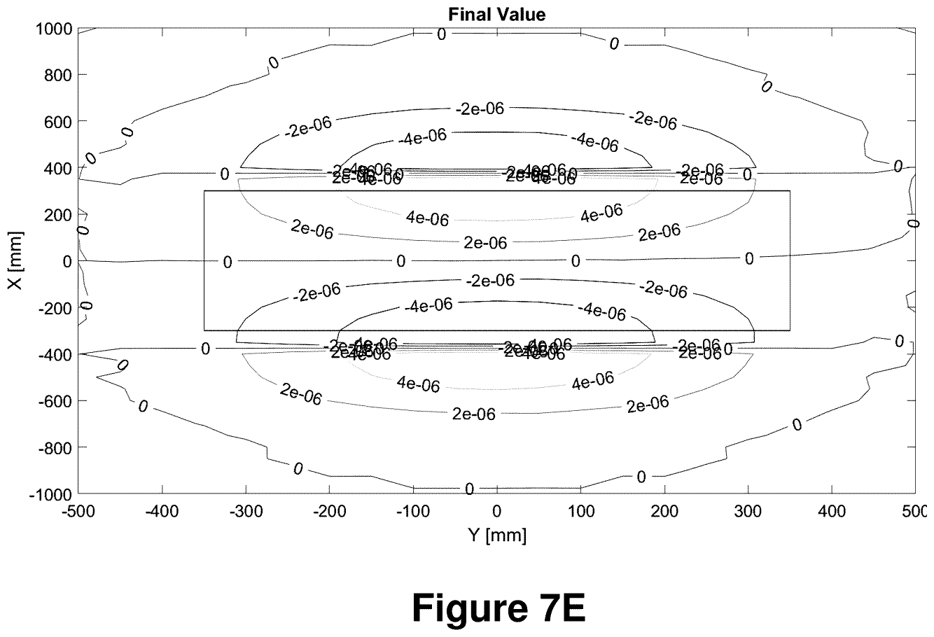

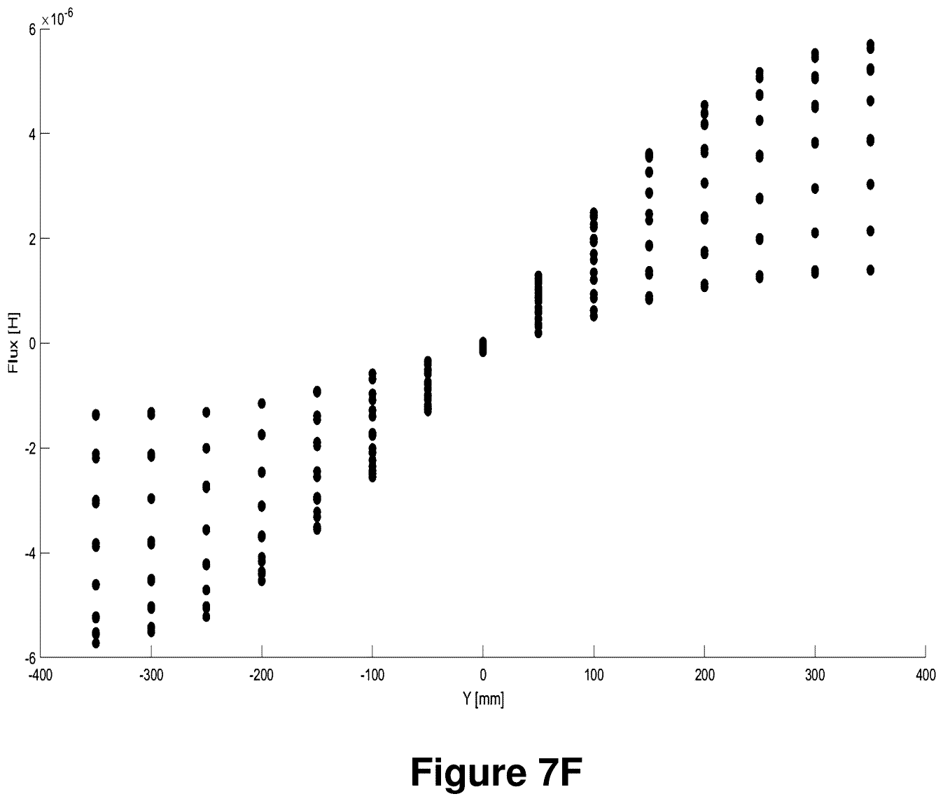

FIGS. 7A-7F shows magnetic flux diagrams of the system in accordance with some embodiments of the present invention.

In several computer simulation carried out by the inventor of the present invention, the following assumption and parameters were used.
All sensing coils are connected ‘high-ohmic’
FEM Simulation output: magnetic Flux in a sensing coil (Bₛₑₙₛ)
Segment current (in Simulation) was Iₛᵢₘ=2 Arms
   Thus, magnetic flux may be larger in reality:
x5 (10 Arms in static positioning 12 V mode)
x35 (70 Arms in dynamic power transfer mode)
Voltage calculation example:
I_Seg=70 Arms (Current of transmitter coil)
B (Sim)=1 μH

$${V}_{sens} = \frac{{I}_{seg}}{2} \cdot {B}_{sens} \cdot ω = 35 A \cdot 1 µH \cdot 2 π \cdot 85 kHz = 18.7 V$$

18.7 V/μH (@70 Arms)
2.7 V/μH (@10 Arms)

It should be noted that the aforementioned arrangement can be scaled up by turn number of sensing coils.

It is further understood that other parameters and values can be used, in order to adjust to other configurations of power-over-the-air transmitting and receiving coils.

In magnetic flux diagrams FIGS. 7A, 7B, and 7C show the raw values of the 3 coils for longitudinal (X) position: DIFF, PLUSX, NEGX.

As explained above, with simple measurement devices (simple rectifier 400 in FIG. 4) only DC values, can be gathered so unsigned as in the following formula:

$${V}_{DC} \approx \vert V ( t ) \vert$$

This means it is not simple to break backward/forward symmetry. This is achieved in accordance with some embodiments of the present invention by employing a discriminator function which couples the DIFF to the PLUSX and NEGX in two serial connections and compared in the following formula:

$$Disc = \vert V ( D + P ) \vert > \vert V ( D + N ) \vert \\ if Disc = true \to X > 0 \\ if Disc = false \to X < 0 \\ for - 400 < X < 400$$

FIG. 7D shows the outcome of applying the aforementioned discriminator function. By this it may be possible, in accordance with some embodiments of the present invention, to determine qualitative X information (only qualitative, as the signal for X position is also Y sensitive) for |X|<400, |Y|<350. These are shown on FIG. 7E and 7F.

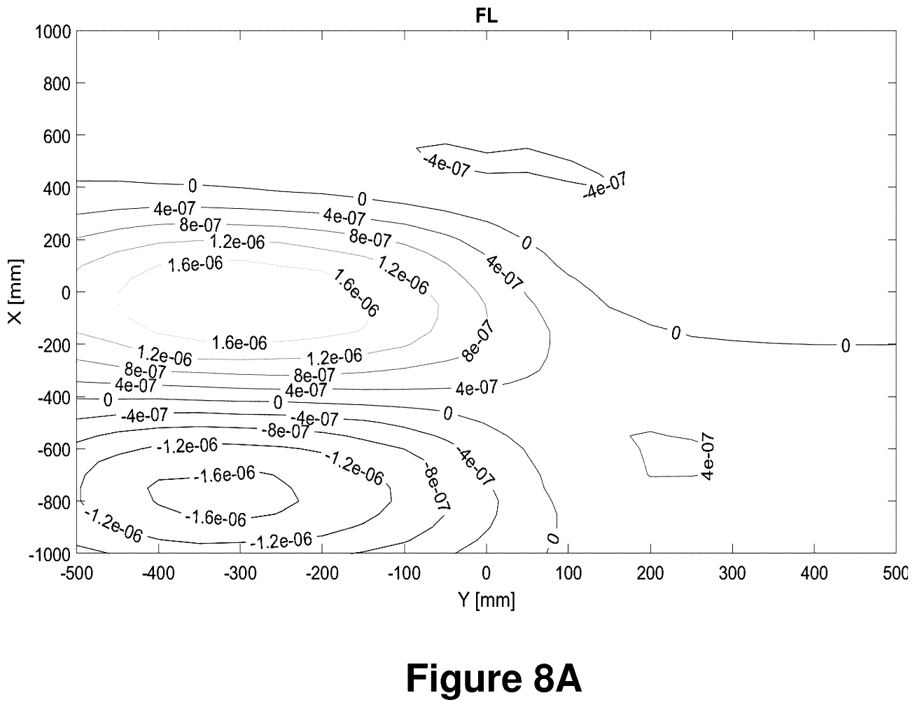

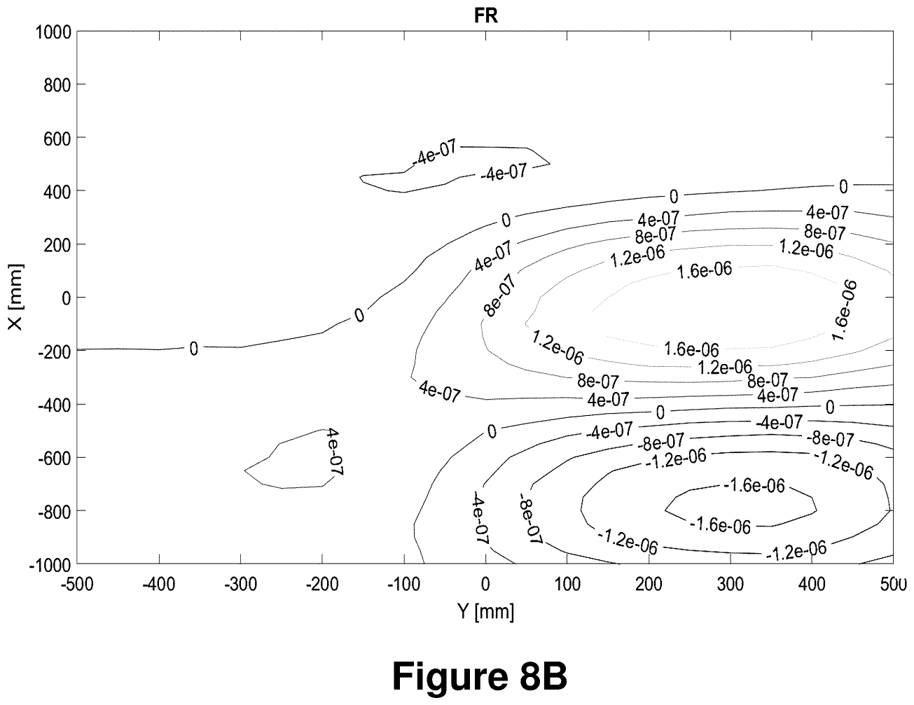

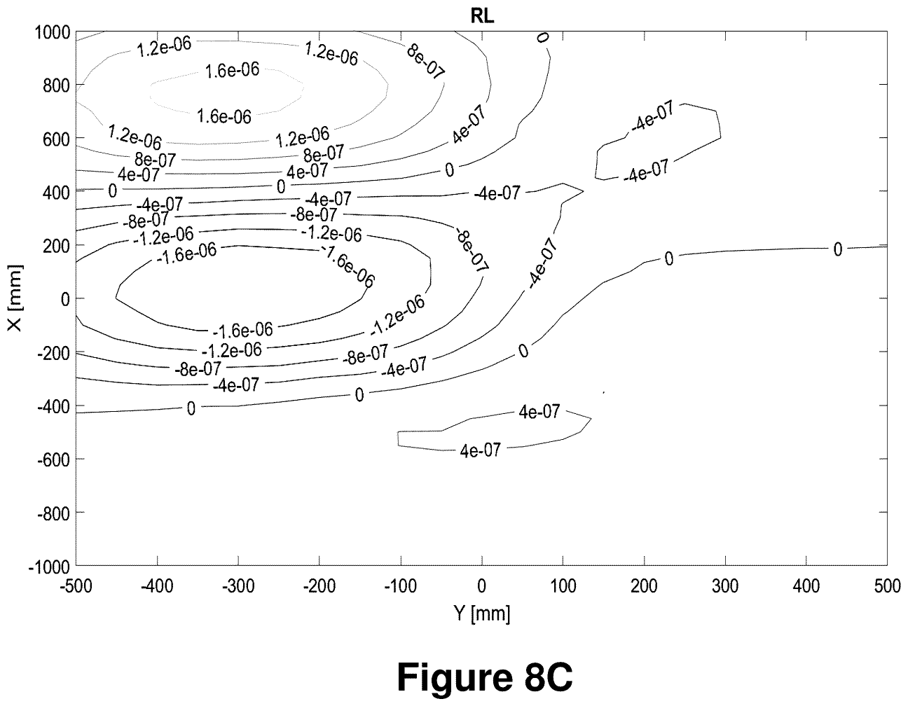

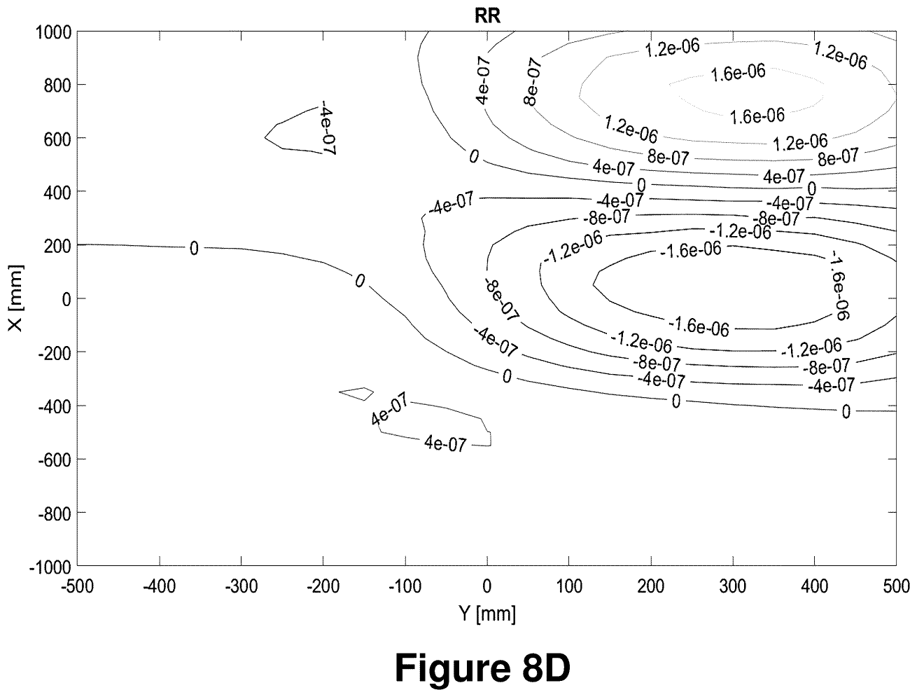

FIGS. 8A-8D show magnetic flux diagrams of the system in accordance with some embodiments of the present invention, each for a coil. FIG. 8A is for the front left coil, FIG. 8B is for the front right coil, FIG. 8C is for the rear left coil, and FIG. 8D is for the rear right coil.

Magnetic flux diagram for static lateral (Y) position may require all four coils in the corners of the receivers are employed. For pure Y position, two would be sufficient, but in static also and angle (yaw) could be relevant. This explains the usage of two pairs.

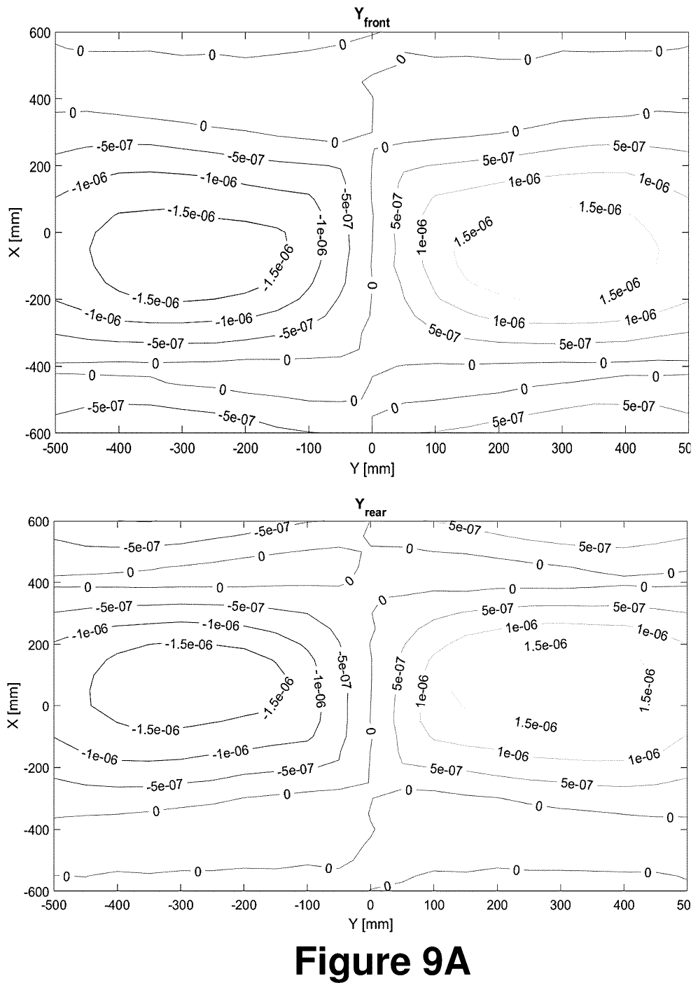

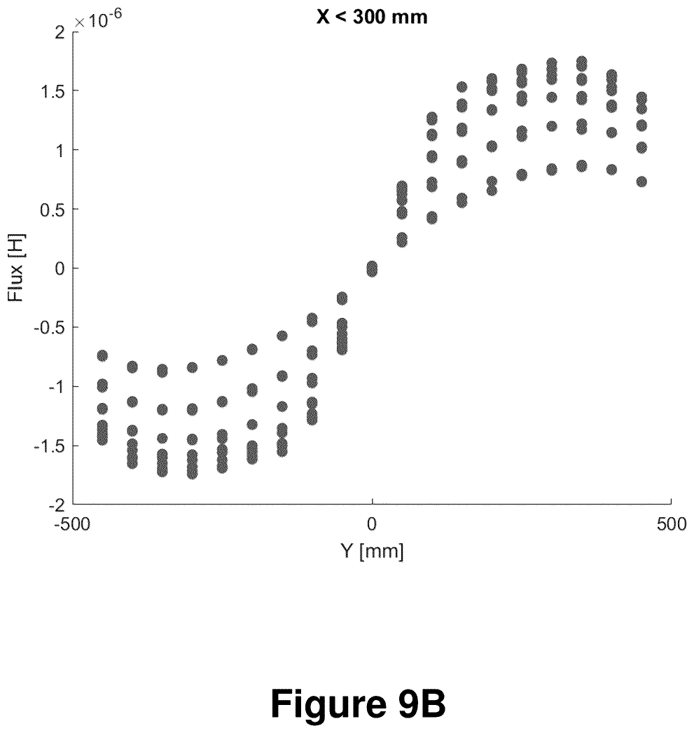

FIG. 9A shows magnetic flux diagrams of the system in accordance with some embodiments of the present invention.

FIG. 9B is a graph diagram showing the relationship between magnetic flux and the position of the electric vehicle accordance with some embodiments of the present invention.

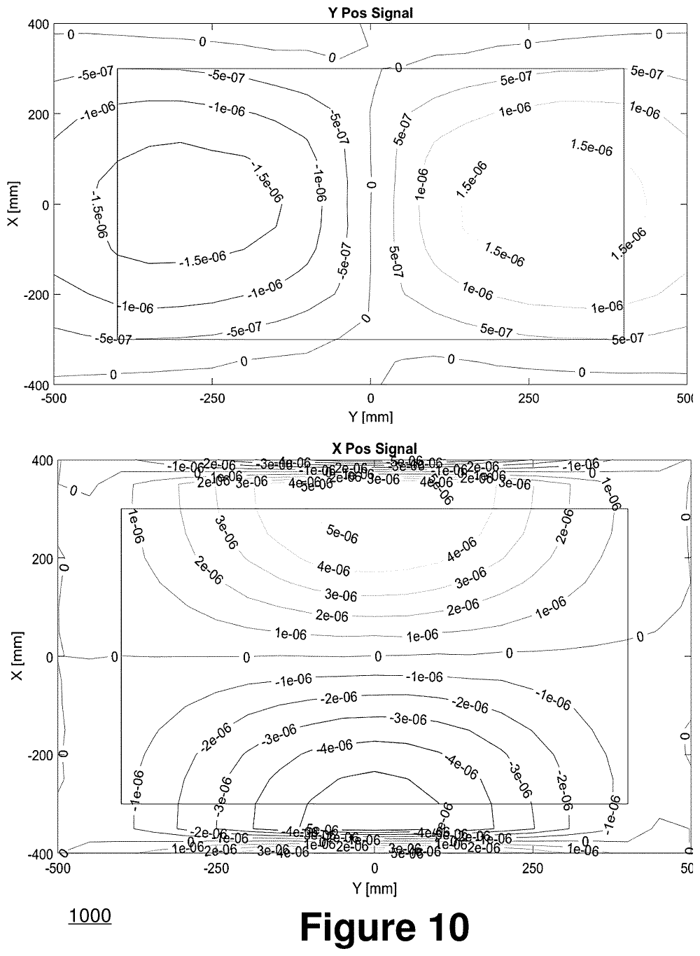

FIG. 10 shows magnetic flux diagrams of the system in accordance with some embodiments of the present invention. Diagram 1000 show magnetic flux at a final static position. As driver guidance, both values shall be minimized, this is rather simple. For example, start with the lateral unless you are centered and afterwards bring longitudinal to X=0.

It would be possible for those skilled din the art to develop an algorithm that provides: X and Y as functions of X_Pos_Signal and Y_Pos_Signal.

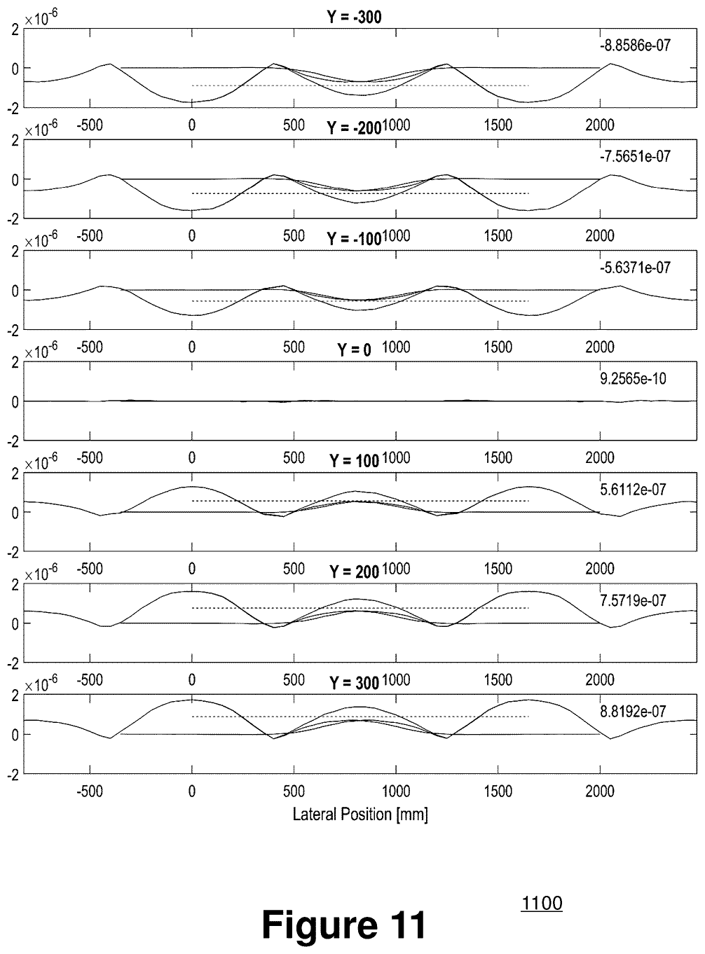

FIG. 11 shows graph diagrams showing the relationship between magnetic flux and the position of the electric vehicle accordance with some embodiments of the present invention.

The plot 1100 shows the values deduced from the sensing coils for lateral misalignment when the vehicle moves at various offsets over multiple segments. Here the centers of two segments are at X=0 and X=1650.

For dynamic lateral, it should be considered that the sensing coils receive a superposition of the magnetic field emitted from two segments. See in figure the blue and orange curves as magnetic flux density from neighboring segments:

$${V}_{final} ( Seg 1 ) = \frac{( \vert FR \vert - \vert FL \vert + \vert RR \vert - \vert RL \vert )}{2} \\ {V}_{final} ( Seg 2 ) = \frac{( \vert FR \vert - \vert FL \vert + \vert RR \vert - \vert RL \vert )}{2}$$

Whereas the blackline indicates the total induced voltage:

$${V}_{final} = {V}_{final} ( Seg 1 ) + {V}_{final} ( Seg 2 )$$

As the system shows a 1650 mm periodicity the relevant interval is x ϵ [0, 1650] and from the region the mean value is indicated.

For stable values, a period longer than the typical interval shall be averaged. Assuming lowest reasonable speed ˜5 m/s: 0.5 s floating average should be fine.

The remainder of the description provides further embodiments and variants of the aforementioned method and system for positioning a vehicle having wireless power transfer based on magnetic flux sensing. While some of the embodiments detailed below provide a simplification of the set-up, some other embodiments are addressing a private case or provide a different type of data for one or more practical implementations.

It should be understood that neither of the embodiments below should serve as limiting the scope of the aforementioned positioning technique.

### Reduction to Two Sensing Coils

In accordance with some embodiments of the present invention, the application of dynamic positioning (which is only one-dimensional: left-right-lateral axis) a single pair of sensing coils may be sufficient. The induced voltages of these pair of sensing coils can be used to deduce relative and/or absolute lateral offsets with respect to the power transfer infrastructure.

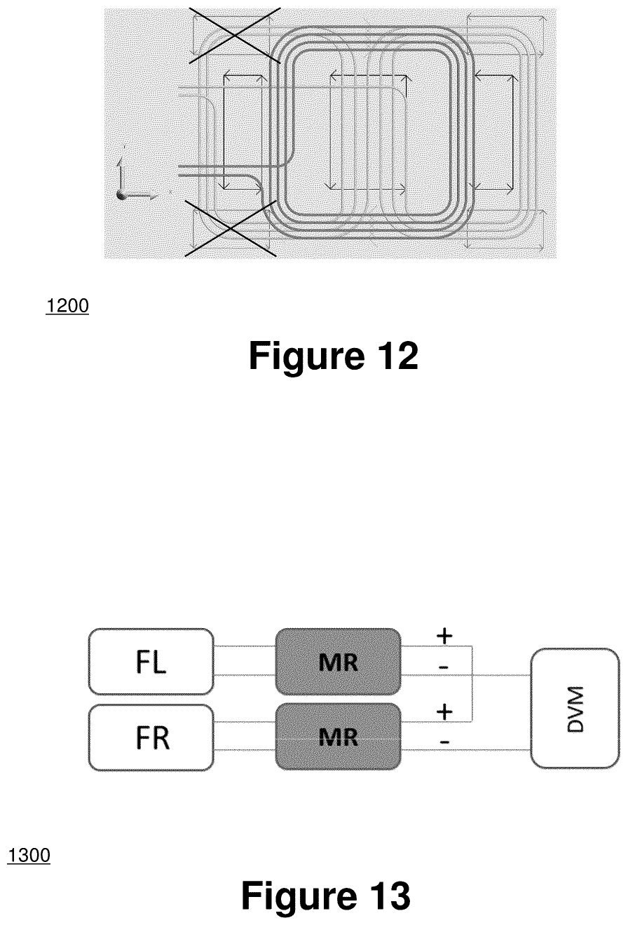

FIG. 12 shows a circuit diagram with eliminated coils as a simplified implementation in accordance with embodiments of the present invention for example: the crossed-out sensing coils in circuit 1200 could be removed, without reducing the functionality of dynamic positioning and guidance.

### Single Channel for Lateral Positioning

In accordance with some embodiments of the present invention, it is suggested by the inventor of the present invention to provide simplified hardware implementation of the positioning system which may only provide the difference value of the induced voltage (differential measurement).

FIG. 13 shows a circuit 1300 with the measurement rectifiers (MR) connected in a differential measurement set-up in accordance with some embodiments of the present invention.

The differential measurement may be sufficient to determine the relative offset of the vehicle with regard to the charging infrastructure. While this positioning may not be suitable for guidance, it would be sufficient for evaluation of the charging status. Typically, the performance of an Electric Road System (ERS) is symmetrical, so if, for example, only the quality of the power transfer needs to be monitored the absolute offset would be sufficient. Potential application of such a positioning may be for example for billing and metering purposes.

### Relative Lateral Measurement by Analog Hardware

In accordance with some embodiments of the present invention, it may be a preferred solution to directly compare the analog positioning signals in order to create a relative position signal on a hardware level. This solution reduces the required computing power and/or reduce potential latency.

In accordance with some embodiments of the present invention, connecting the output of measurement rectifier (or comparable devices) in series and counter-series provides values that can be combined to a value proportional to the lateral offset.

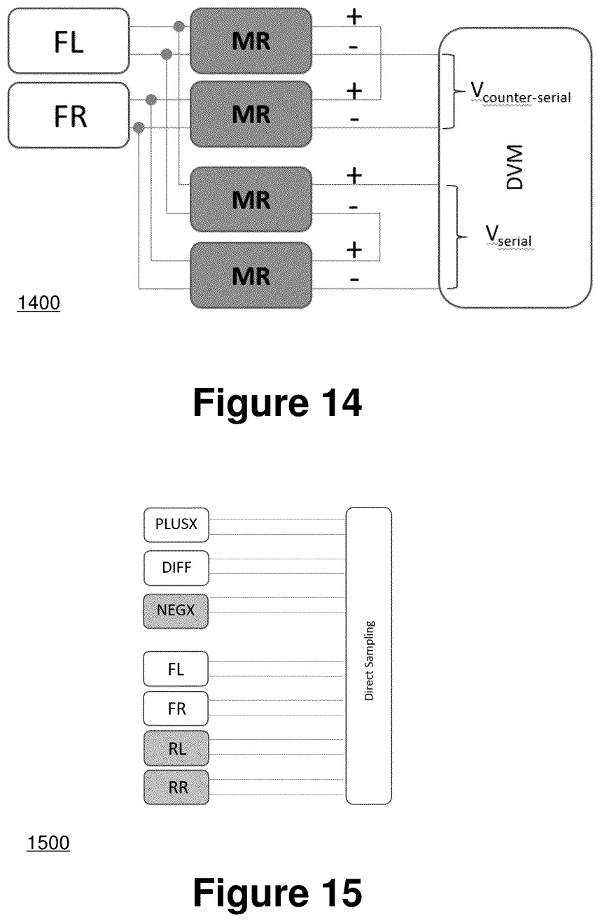

FIG. 14 shows circuit 1400 with the output of measurement rectifier (or comparable devices) connected in series and counter-series thereby providing values that can be combined to a value proportional to the lateral offset.

In accordance with some embodiments of the present invention, two independent measurements are proposed: one with both coils connected in serial (− of one coil to + of the other) and a counter-series connection (+of both coils connected). The measurement is approximated by the following formula:

$$Y ∼ \frac{{V}_{counter - serial}}{{V}_{serial}}$$

### Hardware-Based Time Filtering

In accordance with some embodiments of the present invention, since dynamic position sensing requires time-based filtering, it is suggested by the inventor of the present invention to achieve this on the hardware level, by increasing the capacitance value of the capacitor positioned in parallel of the Measurement Rectifier (MR).

In order to implement hardware-based time filtering by increasing the capacitance value of the capacitor positioned in parallel of the Measurement Rectifier, some exemplary non-limiting values are provided herein for a serial resistor with R=10 Ω and a parallel resistor with R=1 kΩ, the following Table (2) has been produced:

TABLE 2

| Capacitor | Time Constant | Transmitters passed | Transmitters passed |
|---|---|---|---|
| [uF] | τ [ms] | per τ at 10 m/s | per τ at 30 m/s |
| 1 | 1 | <1 | <1 |
| 10 | 10 | <1 | <1 |
| 100 | 100 | <1 | ~2 |
| 500 | 500 | ~3 | ~9 |
| 1000 | 1000 | ~6 | ~18 |

The combination of the values provided in FIG. 5 lead to a time constant of 1 ms. A reasonable time constant for driving on electric road systems could be 500 ms ˜1 s, which typically ensures relatively stable signals while passing multiple transmitters. It is understood that further smoothing and processing of the measurement values are possible.

### Rectifier-Free Measurement

In accordance with some embodiments of the present invention, an alternative to the aforementioned ‘Measurement Rectifier’ (MR) discussed in detail above, it would be possible to further simplify the design and apply direct sampling of the induced voltage (typically 85 kHz) and deduction of Root Mean Square (RMS) values and phase angles between the channels. For this, sampling rates of 500 kHz ˜1 MHz may be sufficient.

FIG. 15 shows circuit 1500 where direct sampling of the induced voltage is implemented in accordance with embodiments of the present invention.

Advantageously, this further simplification may enable to reduce at least one sensing coil for longitudinal positioning. Thus, lateral positioning can be achieved with typically 2 or 4 sensing coils.

### Method for Absolute Determination of the Longitudinal Position

In accordance with some embodiments of the present invention, the position detection system may depend on the on the sensing of a magnetic field that is generated by a transmitter coil. This field is symmetric in X and Y axis. However, the symmetry in the lateral (Y) axis can be ignored as a moving left/right will move one sensor out of the magnetic field and thus, the Y position can be disentangled. For the longitudinal (X) position this is not possible, due to geometry constraints. Especially, the common DD geometry (bi-polar transmitter coils) have a minimum in the center which allows precise positioning.

However, the combination of a ‘differential coil’ and an ‘offset coil’ (FIG. 4, e.g. 250A (offset) and 250B (differential)) allows to identify the sign of the longitudinal position. This method is also applicable for circular transmitters.

### Rotation of the Vehicle

In accordance with some embodiments of the present invention, a rotation of the vehicle around the vertical axis (yaw) could be detected by the independent measurement of the lateral position at the front and rear of the energy-receiver.

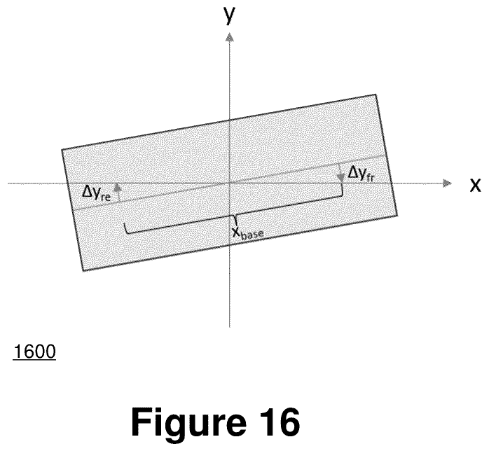

FIG. 16 shows a vehicle turning right. The yaw (φ) angle can be determined by the front and rear Y position offset and the known base length according to the following formula:

$$tan φ = \frac{( Δ {y}_{fr} - Δ {y}_{re} )}{{x}_{base}}$$

It is understood by those skilled in the art, that additional lateral translation could be easily disentangled according to the standard procedure.

### Absolute Positioning Determination

In accordance with some embodiments of the present invention, the combination of lateral and longitudinal pos data enables unambiguous determination of 2d position. Referring back to FIG. 10 the position-signal iso-value lines form circular structures. If both pieces of information are combined this may lead to an unambiguous interception. The provided data could be analyzed with appropriate mathematical methods (e.g. 2D Gaussian fit) or resolved by an artificial network.

### Time-Averaging for Robust Dynamic Positioning Signal

In accordance with some embodiments of the present invention, referring back to FIG. 11 shows a typical pattern for a constant position signal over an ERS. The computational algorithm should provide sufficient filtering to provide a constant signal for a constant position offset, by employing e.g. a “sliding window” filtering or other appropriate methods. Besides providing stable data, the latency shall not be increased too much.

### Speed-Depending Time-Averaging for Appropriate Position Resolution and Latency

In accordance with some embodiments of the present invention, dynamic position information is highly relevant for driver guidance and/or automated driving functionality. It is proposed to set the time-based averaging according to the vehicle speed: a fast-moving vehicle needs to have a more robust signal, whereas slower vehicles can make more agile maneuvers to align themselves to the ERS.

Advantageously, all of the aforementioned embodiments and variants of the electric vehicle positioning system, may be usable for may use cases including but not limited to: on road navigation, cruise control, autonomous cars, and other advanced driver assistance systems (ADAS). For static charging the positioning may be useful in determining the most power efficient location to place the electric vehicle for quicker and more power efficient charging.

The aforementioned flowchart and diagrams illustrate the architecture, functionality, and operation of possible implementations of systems, methods, and computer program products according to various embodiments of the present invention. In this regard, each portion in the flowchart or portion diagrams may represent a module, segment, or portion of code, which comprises one or more executable instructions for implementing the specified logical function(s).

It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit”, “module” or “system”.

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention. It is to be understood that the phraseology and terminology employed herein is not to be construed as limiting and are for descriptive purpose only. The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A system for positioning a wirelessly powered electric vehicle, relative to power transmitting coils located below or on the road, the system comprising:
one or more power coils forming a power receiver segment attached to the electric vehicle;
a set of two or more sensing coils located on the power receiver and connected to respective voltmeters via respective measurement rectifiers;
a set of two or more sensing coils located along a longitudinal centre of the power receiver segment and connected to respective voltmeters via respective measurement rectifiers; and
a computer processor configured to receive readings from the voltmeters and calculate, based on calibration data, a position of the electric vehicle relative to the power transmitting coils,
wherein the calibration data map voltage values representative of magnetic flux though the sensing coils and the power coils, into longitudinal and lateral displacement of the receiver segment, respectively, and
wherein the measurement rectifiers are connected in series with a negative of one coil connected to a positive of another in a first measurement and wherein the measurement rectifiers are connected in counter-series with a positive of one coil connected to a positive of another in a second measurement, thereby providing values that can be combined to a value proportional to a lateral offset of the vehicle.

2. The system according to claim 1, wherein the one or more power coils forming a power receiver segment attached to the electric vehicle comprises three partially overlapping coils forming a power receiver segment attached to the electric vehicle.

3. The system according to claim 1, wherein the voltmeters are digital voltmeters.

4. The system according to claim 1, wherein the voltmeters comprise means for measuring a voltage in the analog domain.

5. The system according to claim 1, wherein the computer processor is further configured to determine the longitudinal position based on the lateral offset.

6. The system according to claim 1, wherein the computer processor is further configured to discriminate forward and backward misalignment of the vehicle, based on differential magnetic measurement.

7. The system according to claim 1, wherein the computer processor is further configured to carry out time-averaging of the voltage readings, thereby providing a robust dynamic positioning signal.

8. The system according to claim 7, wherein said providing a robust dynamic positioning comprises position tracking by averaging lateral sensor data.

9. The system according to claim 7, wherein said providing a robust dynamic positioning comprises automated driving lead or supported by lateral positioning data of an electric road system associated with said power transmitting coils located below the road.

10. A method of using the system of claim 1, for positioning a wirelessly powered electric vehicle, with regards to power transmitting coils located below or on the road.

11. A method of navigation a vehicle along a network of roads using the system according to claim 1.

12. A method of assessing lateral misalignment of a vehicle along a network of roads using the system according to claim 1.

13. A method of assessing the rotation of a vehicle along a curved road using the system according to claim 1.

14. A method for assessing an alignment of transmitting and receiving coils for static charging of a vehicle using the system according to claim 1.

15. A method according to claim 14, further comprising assessing the rotation of a vehicle.

16. A method of assessing a speed of a vehicle along a road, using the system according to claim 1.

17. A method of enabling autonomous and/or automated driving of a vehicle using the system according to claim 1.

18. A method of providing advanced driver assistance system “ADAS” using the system according to claim 1.

19. A method of providing lane departure warning “LDW” using the system according to claim 1.
